(19) United States
(12) Patent Application Publication
(10) Pub. No.: US 2023/0131846 A1
(43) Pub. Date: Apr. 27, 2023

(54) CONTENT PRESENTATION

(71) Applicant: Oleg Vladyslavovych FONAROV, Kharkiv (UA)

(72) Inventor: Oleg Vladyslavovych FONAROV, Kharkiv (UA)

(21) Appl. No.: 17/507,839

(22) Filed: Oct. 22, 2021

(51) Int. Cl. H04N 21/43; H04N 21/81

(52) U.S. Cl. CPC H04N 21/4307; H04N 21/8133; H04N 21/8106

(57) ABSTRACT

The invention relates to the field of content presentation.

A system and a computer-readable medium are described, comprising program instructions, which provide for display of the visual content parts by a display device synchronously with reproduction of the audio content parts by a reproducing device based on the content synchronization information; display of at least one visual content part not synchronized with an audio content part currently being reproduced without interrupting reproduction of the audio content part in response to at least one corresponding action by the user during his interaction with the input device interface; and a subsequent return to display of the visual content parts synchronously with reproduction of the audio content parts in response to at least one corresponding action by the user during his interaction with the input device interface or automatically upon the occurrence of a predetermined event.

The invention relates to the field of content presentation, in particular to systems for synchronous presentation of audio and visual content related in meaning on a user device or devices, as well as to computer-readable media comprising program instructions for said purposes.

In addition to the advantages associated with the creation and distribution, electronic, including audio, books and other forms of digital content, have many advantages for an end user: the devices capable of presenting such content, as well as any other visual and audio information, are more portable and convenient than physical copies. In addition, such devices are often characterized by the presence of both a visual content display device (for example, a display) and an associated audio content reproducing device (for example, a speaker), or separate devices capable of reproducing information and devices capable of display of it may be interconnected, which allows for synchronized presentation of different types of content for matched visual and auditory perception by the user (for example, playing an audiobook through headphones or speakers and display of a part of the book text corresponding to the one being listened on a display of the user device).

For example, the U.S. Pat. No. 9,213,705 discloses a system that provides for synchronization of the provision of audio content with visual content, whereby the corresponding visual content can be displayed on a user device while the latter reproduces the associated audio content. That is, in parallel with audio content reproduction by the audio content reproducing device of the user device, the visual content display device of the latter can display the images directly related to this part of the audio content or the whole audio content.

The U.S. Pat. No. 8,862,255 discloses a synchronized content presentation control system comprising an input device; an audio content reproducing device; a visual content display device; a computer-readable medium; a processor connected to the input device, to the reproducing device, to the display device, and to the computer-readable medium; wherein the computer-readable medium comprises audio content, visual content related in meaning to the audio content, content synchronization information linking the visual content parts to the corresponding audio content parts; and program instructions, which, when executed by the processor, provide for display of the visual content parts by the display device synchronously with reproduction of the audio content parts by the reproducing device based on the content synchronization information. Said system has been chosen as a prototype of the claimed system.

Its disadvantage, as well as the disadvantage of the system according to the U.S. Pat. No. 9,213,705, is the fact that the user, when listening to audio content, has no opportunity to view the visual content that has already been displayed, i.e. opportunity of unsynchronization of audio and visual content. This is essential when the user does not want to interrupt listening to audio information, but wants to refer again to visual information, for example, to recollect some key points disclosed by the visual information. For example, if the user listens to a lecture about design of a device, one of the parts of which refers to certain figures illustrating said design, then when moving to the next part of the audio content, which operates with the illustrated design elements, this time without displaying the figure, the user may seek a possibility of fast display of the desired figure. In addition, sometimes, to fully understand the content, the user may need to look not at one current synchronized unit of content, for example, in the form of the same figure, but to perceive both figures, quickly switching between them without losing the narrative thread. However, the described systems will not be able to provide for such opportunity without interrupting audio content reproduction, as a result of which the narrative story will be interrupted, and the user will need to make manipulations to search for the moment in time, for example on the bar of progress, at which the figures were shown, and, afterwards, to search for the moment in time, at which the stopped lecture reproduction. In addition, when displaying the synchronized visual content, after returning to the moment in time corresponding to the required figure, the user will have to listen again to the corresponding synchronized part of the audio content due to the lack of the possibility of unsynchronization, which is impractical and inconvenient, since the information contained in this part of the audio content has already been listened to, and the user does not need to return to it again.

Thus, the problem to be solved by the present invention is to create such a system for content presentation and a computer-readable medium comprising program instructions for said purposes, which will ensure the achievement of the technical result consisting in the possibility of unsynchronization of the presented visual and audio content without interrupting the reproduction of the latter and a subsequent return to synchronous reproduction of the whole content, thus, ensuring time saving for effective interaction with the content.

The problem is solved by developing a system for content presentation comprising an input device; an audio content reproducing device; a visual content display device; at least one computer-readable medium; at least one processor connected to the input device, to the reproducing device, to the display device, and to the computer-readable medium; wherein at least one computer-readable medium comprises audio content, visual content related in meaning to the audio content, content synchronization information linking the visual content parts to the corresponding audio content parts, and program instructions, which, when executed by the processor, provide for display of the visual content parts by the display device synchronously with reproduction of the audio content parts by the reproducing device based on the content synchronization information, wherein at least one computer-readable medium also comprises program instructions, which, when executed by the processor, provide for display of at least one visual content part not synchronized with an audio content part currently being reproduced without interrupting reproduction of the audio content part in response to at least one corresponding action by the user during his interaction with the input device interface, and a subsequent return to display of the visual content parts synchronously with reproduction of the audio content parts in response to at least one corresponding action by the user during his interaction with the input device interface or automatically upon the occurrence of a predetermined event.

The problem is also solved by developing one or more non-transient computer-readable medium comprising program instructions, which, when executed by the processor connected to the input device, to the reproducing device, to the display device, and to the computer-readable medium, provide for display of the visual content parts by the visual content display device synchronously with reproduction of the audio content parts by the audio content reproducing device based on the content synchronization information linking the visual content parts to the corresponding audio content parts, wherein the medium further comprises program instructions, which, when executed by the processor, provide for display of at least one visual content part not synchronized with an audio content part currently being reproduced without interrupting reproduction of the audio content part in response to at least one corresponding action by the user during his interaction with the input device interface, and a subsequent return to display of the visual content parts synchronously with reproduction of the audio content parts in response to at least one corresponding action by the user during his interaction with the input device interface or automatically upon the occurrence of a predetermined event.

Thus, the claimed system and computer-readable medium enable the user to unsynchronize at any time the reproduced and displayed audio and visual content respectively, wherein the audio content reproduction will continue, while the user will be able to return to the already displayed visual content parts not synchronized with the audio content part currently being reproduced, or, conversely, will be able to view the visual content that has not yet been displayed due to the fact that it is synchronized with the parts of audio content that have not yet been reproduced. The latter may be useful, for example, if the user wants to see how soon the chapter will end by scrolling the pages forward, or to understand what the next chapters/parts of the narrative will be about by looking at the images.

In addition, the above-described capabilities of the program instructions in use allow to perceive two figures (photographs, images, etc.) simultaneously, switching between them and without losing the narrative thread, which, as mentioned above, could not be implemented by the existing systems and makes the experience of using the system similar to the experience of using a printed book, when the user can see, for example, two images on the same page spread at the same time or, if the images are on different spreads, can quickly shift his gaze from the current description to the images on the spreads, holding the page(s) of the book vertically.

Thus, the above-described advantages ensure time saving for effective interaction with the content.

It should be understood that within the scope of this description, the term “presentation” is generic and refers both to display of visual content and reproduction of audio content performed simultaneously (either synchronized or unsynchronized).

In addition, within the scope of present description, the phrase “at least one computer-readable medium comprises” means that audio content, visual content, content synchronization information, and corresponding program instructions may be stored both on a single medium being a part of a user device, in which the content is presented, or a part of a remote server with at least one user device connected thereto, in which the content is presented, and may be distributed in several media being a part of said user device, or a part of a remote server, or both a part of at least one user device and a part of at least one remote server. The content, the content synchronization information, and corresponding program instructions stored on the remote server/servers can thus be retrieved on demand via the Internet. Most preferably, the content and the content synchronization information are stored in machine-readable media of remote servers, and the user retrieves said data via the Internet through a web interface or a separate application (the content and the synchronization information can be transmitted in an encrypted form or can be secured in any other way), or are stored in a machine-readable medium that is an integral part of a device for reading and listening to electronic books (in an abbreviated form—“e-books”), in a format similar to Epub 3.0.

The user device can be a computer, a tablet, a smartphone, an e-book, a smart-TV, a TV set-top box, game consoles, etc., and, as a whole, the content (i.e. both audio and visual) can be presented, i.e. reproduced and displayed, either on one or on several user devices at the same time (for example, the visual content can be presented on a smart-TV, and the audio content can be presented on a smartphone to which headphones are connected). Thus, the input device, the reproducing device, and the display device can be a part of one user device or several user devices, wherein preferably the input device is a part of a user device that presents the entire content, or is a part of a user device that presents audio content only, or visual content only, although a person skilled in the art will appreciate that it is also possible to implement the input device in a separate user device, which thus is to be connected to the user device or devices in which the content is presented.

Preferably, the visual content may be video content and/or text content and/or images. Thus, the visual content may be either one or several types of visual content, for example, text and images at the same time. In this case, an embodiment of the claimed system is possible, in which the visual content in the form of images can be unsynchronized, while the textual visual content can not be unsynchronized, i.e. if the audio content and images are out of sync, the text will continue to be displayed, repeating the audio content being listened to, for example, in the form of subtitles. By analogy, it is assumed that three types of visual content, such as text, images and video, can be used simultaneously.

The images may be, for example, pictures, graphs, tables, photographs, etc. The video content may be, but not limited to, a series of photographs or images that change with a certain effect (one picture fading out and another picture appearing, page flicking like in a paper book, etc.).

Content synchronization can be performed at various levels, for example, synchronization of every word of the audio content and every word of the text; synchronization of phrases consisting of several words; synchronization of several sentences or paragraphs; synchronization of images and the audio content part corresponding to the image in the form of a phrase, sentence, paragraph or several paragraphs, etc. Thus, within the scope of the present invention, the audio content part may be at least one of a word, a phrase, a sentence, a paragraph, etc., and the visual content part may be at least one of a word, a phrase, a sentence, a paragraph, a single image, a single video content part, etc. (depending on the type or types of visual content).

The actions by the user in response to which at least one visual content part not synchronized with the audio content part currently being reproduced is displayed and display of the visual content parts synchronously with reproduction of the audio content parts is returned to, may be, for example, selection by the user of an appropriate option on the input device user interface, which, in turn, can be a keyboard, a mouse, a trackball, a trackpad, a joystick, a tablet, a trackpoint, a touchscreen, a remote control, a game controller, or any other input device capable of receiving commands from the user.

In this case, the reproduction device can be a speaker or any of a variety of digital or analogue audio output ports, including, but not limited to, headphone jacks, ¼-inch jacks, XLR jacks, stereo jacks, RCA jacks, optical ports, or USB ports. In addition, within the scope of this application, audio content reproducing devices should also be understood as audio devices connected using wireless data transmission technologies (for example, a Bluetooth headset, headphones or an audio speaker). The display device, in turn, may include any type of displays allowing for display of visual digital content.

A predetermined event, in response to which the return to display of visual content parts synchronously with reproduction of audio content parts can be performed, may be, for example, expiry of a predetermined period of time after display of a visual content part not synchronized with the audio content part currently being reproduced, or, for example, the start of reproduction of the next part of audio content. It is apparent that such an event is not limited to the above examples, and any other event can be used as a trigger causing a return to content synchronization.

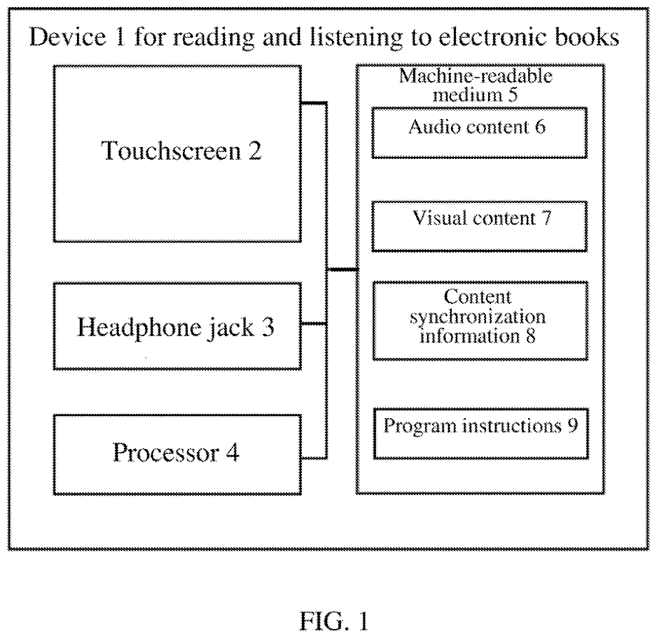

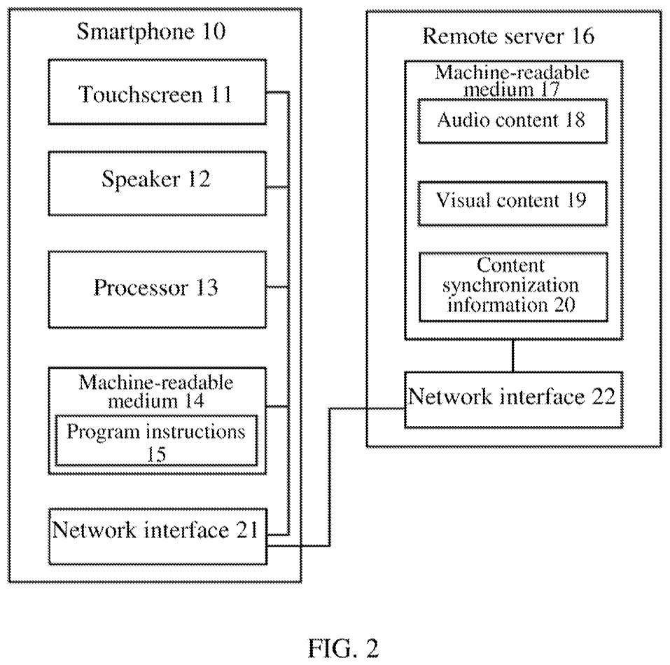

The claimed invention will now be described in more detail with reference to FIGS. 1 and 2, showing a general schematic view of two preferred embodiments of a system for content presentation.

FIG. 1 shows a system for content presentation in the form of a device 1 for reading and listening to electronic books, comprising an input device and a visual content display device in the form of a touchscreen 2, an audio content reproducing device in the form of a headphone jack 3, a processor 4 and a machine-readable medium 5. Said computer-readable medium 5 stores audio content 6, visual content 7, content synchronization information 8, as well as program instructions 9, including program instructions, which, when executed by the processor 4, provide for display of the visual content 7 parts by the visual content display device (the touchscreen 2) synchronously with reproduction of the audio content 6 parts by the audio content reproducing device (the jack 3) based on the content synchronization information 8, as well as including program instructions, which, when executed by the processor 4, provide for display of at least one visual content 7 part not synchronized with the audio content 6 part currently being reproduced without interrupting reproduction of the audio content 6 part in response to at least one corresponding action by the user during his interaction with the input device interface, i.e. the touchscreen 2, and a subsequent return to display of the visual content 7 parts synchronously with reproduction of the audio content 6 parts in response to at least one corresponding action by the user during his interaction with the touchscreen 2 interface.

FIG. 2 shows a system for content presentation, comprising a smartphone 10, which, in its turn, comprises an input device and a content display device in the form of a touchscreen 11, a content reproducing device in the form of a speaker 12, a processor 13 and a machine-readable medium 14. Said computer-readable medium 14 stores program instructions 15 similar to those described above with respect to the system shown in FIG. 1. The system also comprises a remote server 16 with a computer-readable medium 17, which, in its turn, stores audio content 18, visual content 19, as well as content synchronization information 20. The smartphone 10 and the remote server 16 are connected to each other via a network such as the Internet by means of network interfaces 21 and 22, respectively.

The claimed system according to FIGS. 1 and 2 operates as follows.

The content is synchronized automatically, semi-automatically, or manually, for example, using a web interface or a separate application. The content is synchronized by mapping (correlation), wherein content synchronization information to be stored in a computer-readable medium is obtained. In the embodiment shown in FIG. 1, the content synchronization information 8 is stored in the computer-readable medium 5 of the device 1 for reading and listening to electronic books; in the embodiment shown in FIG. 2, the content synchronization information 20 is stored in the computer-readable medium 17 of the remote server 16.

By way of example, synchronization of audio content and text content may be performed as follows, as described in the U.S. Pat. No. 6,260,011. The spoken words in audio content are recognized and translated into text format; the time stamps of each spoken word are determined; the resulting text is divided into phrases, taking into account pauses, but not exceeding a certain number of words in a phrase; the recognized words in phrases are compared with the words in the phrases of the available original text; if possible, the keywords of the beginning and end of each phrase are defined; an assumption is made that the number of recognized words matches the number of words in the original text; the discrepancy between the number of recognized words and the number of words in the original text is eliminated in an algorithmic way: the recognized words in the phrase are compared with the words in the original text. If there is a complete match, the phrase is considered suitable; if there is a mismatch, the outermost words in the adjacent phrases are compared. When there is a word shift in the phrases, word hyphenation is performed. Also, when a discrepancy is detected between the recognized text from the audio content and the original text, the user is provided with an opportunity of manual synchronization by means of the web interface or a separate application, for example, by highlighting the phrases not synchronized or by indicating them in any other way.

Initially, the user is provided with a default, i.e. set by the manufacturer, content presentation mode that best matches the content presented. In particular, such a default mode may be display of the text content 7 or 19 part on the touchscreen 2 or 11 synchronously with reproduction of the audio content 6 or 18 parts using the headphone jack 3 or the speaker 12 of the device 1 or a smartphone 10 based on the content synchronization information 8 or 20, respectively. Simultaneously, the user is provided with an opportunity of manually switching this mode. In particular, in response to the corresponding one or more actions by the user during his interaction with the input device interface (in particular, with the touchscreen 2 or 11), the text content parts not synchronized with the audio content part currently being reproduced are displayed in full-screen format without interrupting reproduction of the current audio content part. Thus, the user can optionally view the entire text content (both the one already displayed and the one that has not yet been viewed) without stopping audio content reproduction. In this case, the user is provided with an opportunity to change at any time the content presentation mode to a synchronous one, i.e. in response to the corresponding one or more actions by the user during his interaction with the input device interface, to return the synchronization of display of the text content parts and reproduction of the audio content parts.

Thus, a system for content presentation and a computer-readable medium comprising program instructions for said purposes have been developed, which ensure the achievement of the technical result consisting in the possibility of unsynchronization of the presented visual and audio content without interrupting the reproduction of the latter and a subsequent return to synchronous reproduction of the whole content, thus, ensuring time saving for effective interaction with the content.

1. A non-transient system for content presentation comprising:
an input device;
an audio content reproducing device;
a visual content display device;
at least one non-transient computer-readable medium;
at least one processor connected to the input device, to the reproducing device, to the display device, and to the non-transient computer-readable medium;
wherein at least one non-transient computer-readable medium comprises:
audio content that contains audio content parts,
visual content that contains visual content parts related in meaning to the audio content, content synchronization information linking the visual content parts to the corresponding audio content parts;
and program instructions, which, when executed by the processor, provide for
display of the visual content parts by the display device synchronously with reproduction of the audio content parts by the reproducing device based on the content synchronization information,
characterized in that
at least one non-transient computer-readable medium comprises program instructions, which, when executed by the processor, provide for:
display of at least one visual content part not synchronized with an audio content part currently being reproduced without interrupting reproduction of the audio content part in response to at least one corresponding action by the user during his interaction with the input device interface,
and a subsequent return to display of the visual content parts synchronously with reproduction of the audio content parts in response to at least one corresponding action by the user during his interaction with the input device interface or automatically upon the occurrence of a predetermined event.

2. The system of claim 1, wherein the visual content is video content and/or text content and/or images.

3. The system of claim 1, wherein the audio content part is at least one of a word, a phrase, a sentence, a paragraph, and the visual content part is at least one of a word, a phrase, a sentence, a paragraph, a single image, a single video content part.

4. The system of claim 1, wherein the action by the user is selection of an appropriate option on the input device interface.

5. The system of claim 1, wherein the predetermined event is expiry of a predetermined period of time after display of a visual content part not synchronized with the audio content part currently being reproduced.

6. A non-transient computer-readable medium comprising:
program instructions, which, when executed by the processor, provide for
display of the visual content parts by the visual content display device synchronously with reproduction of the audio content parts by the audio content reproducing device based on the content synchronization information linking the visual content parts to the corresponding audio content parts,
characterized in that
it comprises program instructions, which, when executed by the processor, provide for
display of at least one visual content part not synchronized with an audio content part currently being reproduced without interrupting reproduction of the audio content part in response to at least one corresponding action by the user during his interaction with the input device interface,
and a subsequent return to display of the visual content parts synchronously with reproduction of the audio content parts in response to at least one corresponding action by the user during his interaction with the input device interface or automatically upon the occurrence of a predetermined event.

7. A non-transient computer-readable medium of claim 6, wherein the visual content is video content and/or text content and/or images.

8. A non-transient computer-readable medium of claim 6, wherein the audio content part is at least one of a word, a phrase, a sentence, a paragraph, and the visual content part is at least one of a word, a phrase, a sentence, a paragraph, a single image, a single video content part.

9. A non-transient computer-readable medium of claim 6, wherein the action by the user is selection of an appropriate option on the input device interface.

10. A non-transient computer-readable medium of claim 6, wherein the predetermined event is expiry of a predetermined period of time after display of a visual content part not synchronized with the audio content part currently being reproduced.
